(19) United States
(12) Patent Application Publication
(10) Pub. No.: US 2012/0181156 A1
(43) Pub. Date: Jul. 19, 2012

(54) GAS-INSULATED HIGH-VOLTAGE SWITCHING SYSTEM

(75) Inventors: Thomas BETZ, Langenselbold (DE); Hauke Peters, Hanau (DE); Thomas Braun, Nieder Erlenbach (DE); Volker Thomas, Hanau (DE); Tobias SCHÖNBERG, Oberelbert (DE)

(73) Assignee: ABB TECHNOLOGY AG, Zurich (CH)

(21) Appl. No.: 13/367,901

(22) Filed: Feb. 7, 2012

Related U.S. Application Data
(63) Continuation of application No. PCT/EP2010/004823, filed on Aug. 6, 2010.

(30) Foreign Application Priority Data
Aug. 7, 2009 (DE) 10 2009 036 590.7

(51) Int. Cl. H01H 31/24

(52) U.S. Cl. 200/48 R

(57) ABSTRACT

A gas-insulated high-voltage switching includes a housing having a switch module including an actuator, a control module, a cable outlet, a transformer, a circuit breaker, and a grounding switch. The circuit breaker and the grounding switch are spatially and structurally separated from one another and may be operated by a common actuator.

### RELATED APPLICATIONS

This application claims priority as a continuation application under 35 U.S.C. §120 to PCT/EP2010/004823, which was filed as an International Application on Aug. 6, 2010 designating the U.S., and which claims priority to German Application 10 2009 036 590.7 filed in Germany on Aug. 7, 2009. The entire contents of these applications are hereby incorporated by reference in their entireties.

### FIELD

The present disclosure relates to a three-phase gas-insulated high-voltage switchgear assembly. More particularly, the present disclosure relates to a three-phase gas-insulated high-voltage switchgear assembly in each case having one switch module with a drive for each phase, at least one busbar, a control module, a cable outgoer, a current transformer, a disconnector, and a grounding switch in each case for each phase.

### BACKGROUND INFORMATION

It is generally known for gas-insulated high-voltage switchgear assemblies to be used when the available space is limited and it is therefore difficult or impossible to use bulky outdoor switchgear assemblies. In this case, the particular minimal space requirements provided by gas-insulated high-voltage switchgear assemblies have been found to be advantageous.

The compact dimensions, which are governed by the switching power and are achieved by isolation by means of insulating gas, for example SF₆, allow gas-insulated high-voltage switchgear assemblies to have comparatively small physical sizes. In this case, their compact modular design is advantageous, allowing the installation of the gas-insulated high-voltage switchgear assembly close to the point of power consumption with high energy efficiency, that is to say with low electrical losses.

Further advantages which may be mentioned are the high operational safety and reliability, and therefore fewer power failures, which are adversely affected neither by regions where there is a risk of earthquakes nor by environmental pollution or by salt mist in coastal regions.

Low operating costs and minimal maintenance effort with a high safety level for the operator, because all of the parts which carry high voltage are completely encapsulated, add to the list of the advantages of gas-insulated high-voltage switchgear assemblies.

Essentially, gas-insulated high-voltage switchgear assemblies consist of a circuit breaker with a drive, a disconnector/grounding switch, which are arranged separately or in combination, and a switch controller.

EP 0 824 264 B1 has disclosed a disconnector/grounding switch module for gas-insulated high-voltage switchgear assemblies, which is arranged in a separate T-shaped housing. The moving contact piece is guided therein as a linear-travel contact piece in a fixed-position conductor part with a drive. In order to allow a space-saving, compact design, the fixed-position conductor part is arranged obliquely in the interior of the disconnector/grounding switch housing, and this has led to the expression oblique linear-travel disconnector.

In this case, two limit positions are provided for the linear-travel contact piece, specifically a first limit position in which the linear-travel contact piece is inserted into the disconnecting contact piece, and thus closes the circuit, and a second limit position, in which grounding is provided by insertion of the linear-travel contact piece into the grounding contact.

When the circuit is interrupted by the circuit breaker, the linear-travel contact piece can be pulled out of the disconnecting contact piece, and the circuit which has been disconnected from the power supply by the circuit breaker can be disconnected and connected to the grounding conductor by subsequent insertion into the grounding contact piece.

The known disconnector/grounding switch has the disadvantage that the current carrying capability of the linear-travel contact piece which is provided for connection to the disconnecting contact piece is directly linked to the short-circuit resistance of the grounding contact. That is to say, the grounding contact is unnecessarily designed for a higher electrical switching power than is intrinsically required, or the higher current carrying capability which is intrinsically desired for the disconnector cannot be achieved in this case, because of the grounding switch and the complexity which is intrinsically not required for its operation.

### SUMMARY

An exemplary embodiment of the present disclosure provides a three-phase gas-insulated high-voltage switchgear assembly which includes a housing with in each case one corresponding switch module with a drive for each phase. The exemplary switchgear assembly also includes at least one busbar, a control module, a cable outgoer, a current transformer, a disconnector, and a corresponding grounding switch in each case for each phase. The disconnector and the grounding switch being spatially and physically separated from one another and are operable by a common drive.

### BRIEF DESCRIPTION OF THE DRAWINGS

Additional features, advantageous refinements and improvements of the present disclosure as well as particular advantages thereof will be explained and described in more detail with reference to exemplary embodiments of the present disclosure, which are illustrated in the attached drawings, in which:

FIG. 1 shows a schematic illustration of a first three-pole contact arrangement of a disconnector/grounding switch according an exemplary embodiment of the present disclosure in the neutral position with stationary contacts at a distance from one another for the disconnector, and a stationary contact with a circular recess for the grounding switch, in the form of a side view, that is to say looking at the switch poles which are in this case arranged alongside one another and the moving disconnecting and grounding contacts which can be moved transversally with respect thereto on a common shaft in each case;

FIG. 2 shows various variants of the conductor pole arrangements from the view “Z” as shown in FIG. 1, within the disconnector/grounding switch housing according to an exemplary embodiment of the present disclosure;

FIG. 3a shows the contact arrangement, in a similar manner to FIG. 1, in the neutral position (disconnector and grounding switch open) and a longitudinal section along the section line A-A through a switch with the contour of an exemplary embodiment of the present disclosure, with the moving contacts of each phase being arranged separately alongside one another;

FIG. 3b shows the contact arrangement as shown in FIG. 3a in the grounding position (disconnector open) as well as a longitudinal section along the section line A-A through a switch with the contour of an exemplary embodiment of the present disclosure;

FIG. 3c shows the contact arrangement as shown in FIG. 3a in the current-carrying position (disconnector closed and grounding switch open) as well as a longitudinal section along the section line A-A through a switch with the contour of an exemplary embodiment of the present disclosure;

FIG. 3d shows a schematic illustration of three different variants of the switch pole arrangement of the first contact arrangement, arranged in parallel, in delta and obliquely, respectively;

FIG. 4a shows a schematic illustration of the three phases of a disconnector/grounding switch according to an exemplary embodiment of the present disclosure of a second contact arrangement in the neutral position (all switching contacts open);

FIG. 4b shows a schematic illustration of the three phases of a disconnector/grounding switch according to an exemplary embodiment of the present disclosure of a second contact arrangement in the grounding position (disconnecting contact open, grounding contact closed);

FIG. 4c shows a schematic illustration of a second arrangement of the three phases of a disconnector/grounding switch according to an exemplary embodiment of the present disclosure of a second contact arrangement in the current-carrying position (disconnecting contact closed, grounding contact open);

FIG. 4d shows a schematic illustration of the switch pole arrangement of the second contact arrangement of a disconnector/grounding switch according to an exemplary embodiment of the present disclosure with concentric (annular) stationary contacts for the disconnector and for the grounding switch, for each switch pole, on the one hand arranged in delta and on the other hand arranged obliquely, respectively;

FIG. 5 shows a schematic illustration of the longitudinal section through a third contact arrangement of a disconnector/grounding switch according to an exemplary embodiment of the disclosure, as a combination of a linear-travel disconnector with the linear-movement principle of a grounding having a translationally moving linear-travel contact piece for the disconnector and having a moving pin contact piece, which likewise moves translationally transversally (orthogonally) with respect thereto, for the grounding contact in three different switch positions, namely:

FIG. 5a in the neutral position (disconnector and grounding switch open);

FIG. 5b in the closed position of the disconnector (grounding switch open);

FIG. 5c in the grounding position (disconnector open and grounding switch closed); and

FIG. 5d shows the arrangement as shown in FIG. 5, but with an angled conductor piece.

### DETAILED DESCRIPTION

Exemplary embodiments of the present disclosure provide a disconnector for a gas-insulated high-voltage switchgear assembly in which the disconnector is very compact for a considerably higher current carrying capability. As a result, the required overall volume of the switchgear assembly is not increased, or is at most increased insignificantly. Exemplary embodiments of the present disclosure also ensure the grounding function of the switchgear assembly, with the aim of keeping its production effort as low as possible.

An exemplary embodiment of the present disclosure provides a three-phase gas-insulated high-voltage switchgear assembly which includes a housing with in each case one corresponding switch module with a drive for each phase. The exemplary switchgear assembly also includes at least one busbar, a control module, a cable outgoer, a current transformer, a disconnector, and a corresponding grounding switch in each case for each phase. The disconnector and the grounding switch being spatially and physically separated from one another and are operable by a common drive.

The disclosure accordingly provides that, although the disconnector and the grounding switch are spatially and physically separated from one another, they can, however, be operated by a common drive. In this case, they are operated alternately, that is to say either the contact between the disconnecting contact, which is connected to the outgoer, and the current-carrying conductor contact on the feed side is made, or this connection is disconnected and the outgoer is connected to the grounding contact.

In this context, the feed side means that switch side which is connected to the high-voltage power supply. In contrast, each disconnector and grounding switch is used for connection to the outgoer side or to the ground potential, in order to switch the relevant path through the switchgear assembly such that it carries no current and is not live. A plurality of outgoers are frequently connected to a feed side.

Here and in the following text, this always means the three-phase version of the switchgear assembly and of the relevant switchgear assembly module, even when only a single contact is mentioned, that is to say except in the situations in which reference is expressly made to a specific single-phase or single-pole version, the three-phase nature of the relevant components.

In accordance with an exemplary embodiment of the present disclosure, the disconnector has a higher current carrying capability than the grounding switch. This is achieved by the higher current carrying capability of the disconnector being achieved by the disconnector having a larger contact cross section than the grounding switch.

While, until now, the advantage has been seen in a single drive being required as far as possible for operation of the moving disconnecting contact piece and the grounding contact piece, which was achieved, by way of example, in the known devices by providing only a single moving contact piece for making contact between the disconnecting contact and the grounding contact, which is operated by a single drive by means of a rotating spindle or by means of a toothed-rod drive, exemplary embodiments of the present disclosure depart from this approach, and make use of other possibilities.

Exemplary embodiments of the present disclosure, of course, also provide only a single drive, but the present disclosure provides for the operation by the single drive to be carried out by means of transmission elements such that the common drive acts alternately on the moving contact pieces, which are separated from one another.

This single drive for operation of the moving disconnecting contact and the moving grounding contact is provided for all three phases, which are jointly surrounded by the relevant housing, within the scope of the present disclosure. In other words, the moving disconnecting contacts and the moving grounding contacts of all three phases are operated by a single drive, which is mechanically coupled appropriately to the switching elements of the individual phases, for transmission to such switching elements.

According to an exemplary embodiment of the gas-insulated high-voltage switchgear assembly according to the present disclosure, the disconnector is accordingly in the form of a line disconnector with horseshoe contact pieces. That is to say, the moving contact of the disconnector is moved along a straight line into the feed-side stationary contact piece, and out of it.

The outgoer-side stationary contact of the combined switch is also provided with a hole in which the grounding switch engages, as a pin contact for making contact. The cross section of the pin contact is in this case designed for a grounding function and is correspondingly smaller than the cross section of the disconnecting contact piece.

The moving contact pieces of each switch or switch pole can be operated alternately via an appropriate mechanism, for example, a switching rocker or a rocker transmission.

An advantage which is achieved by the contact configuration as described above is that considerably less space is required for the two contacts, in comparison to known devices. The disconnector and grounding switch known from the conventional techniques requires a movement path whose length corresponds to at least seven times the minimum isolating distance because of the linear movement of the moving contact piece.

In contrast, the space requirement for the configuration according to the present disclosure with a line disconnector with horseshoe contact pieces, which are arranged opposite one another with a simple isolating distance, and a grounding switch which is in the form of a pin contact and which is inserted into an appropriately provided hole in the disconnector in order to make contact, is considerably less, such as five times the isolating distance, for example.

This means that the minimum separation between the contacts to be connected and to be disconnected and which results from the voltage level is all that need to be maintained with the configuration according to exemplary embodiments of the present disclosure.

In accordance with an exemplary embodiment, the horseshoe stationary contact pieces can be connected to the feed-side conductor coming from the circuit breaker on the one hand and to the outgoing conductor piece on the other hand, with the openings in the horseshoe contact pieces facing one another. In order to make the electrical connection between the feed-side and the outgoer-side contact of the disconnector, the moving contact piece of the disconnector can be pivoted into the contact point in order to make contact between the contacts, or is moved laterally, that is to say transversally with respect to its longitudinal axis.

The retaining hole which has been mentioned for the grounding contact piece, which is in the form of a pin, is arranged at a distance from the horseshoe contact on the stationary contact piece which is connected to the outgoing conductor. The moving grounding contact piece may, of course, also be tubular. All that is necessary is to appropriately match the available wall cross section to the minimum current carrying capability required for grounding.

The respective mutually associated disconnecting stationary contact pieces are larger than the contact area of the retaining hole for the grounding contact piece. That is to say, they have a larger contact-making cross section by appropriate enlargement of the opening width. Correspondingly, the moving disconnecting contact piece which is inserted therein likewise has a larger diameter, and therefore a larger circumferential area, than the contact area for making contact with the stationary contact pieces.

When the switching rocker or the rocker transmission acts thereon, the moving disconnecting contact piece is moved from the neutral or grounding position toward the stationary contact pieces, and is inserted between the horseshoe stationary contact pieces, which are arranged opposite one another, by pivoting or lateral movement, while the moving grounding contact piece is moved in the opposite direction, parallel to its longitudinal axis.

In accordance with an exemplary embodiment, only when the circuit breaker has interrupted the power supply can the moving disconnecting contact piece be moved to the disconnected position without risk of damage, that is to say away from the stationary contact pieces and, as the process continues, the grounding contact piece, which is in the form of a pin, is moved into the hole provided for this purpose by the rocker drive, in order to make contact.

In this way, this exemplary embodiment of the gas-insulated high-voltage switchgear assembly according to the present disclosure offers a space-saving solution.

According to an exemplary embodiment of the gas-insulated high-voltage switchgear assembly according to the present disclosure, the disconnector and the grounding switch are arranged concentrically with respect to one another, with the disconnector concentrically surrounding the grounding switch, at a distance.

It is clear from this that the radially externally located disconnecting contact necessarily has a larger contact cross section than the centrally arranged grounding contact. In this exemplary embodiment, the contact is in each case likewise made with two different contact pieces which are moved in opposite senses, such that, as already mentioned above, only one contact point is ever closed.

An advantage of this concentric contact arrangement is the considerably reduced space requirement for safe disconnection. While the disconnector and grounding switch in known devices requires a movement path whose length corresponds at least to seven times the minimum isolating distance because of the linear movement of the moving contact piece, the switching path required for the moving contact pieces in the concentric contact arrangement is only three times the isolating distance.

This means that the moving contact piece must in fact have a sufficiently large contact area both in the contact in which it is guided and furthermore the minimum distance from the mating contact must be complied with, and finally must also make contact with a sufficiently large contact area with the mating contact when operated. It can be seen from this that it is impossible to remain among these parameters, and a smaller physical size therefore cannot be achieved.

An exemplary embodiment of the gas-insulated high-voltage switchgear assembly according to the present disclosure provides that the disconnector is in the form of a linear-travel disconnector, and the grounding switch is in the form of a rotary switch.

In this case, contact is made in the disconnector in a similar manner to that described in known devices, specifically by axial, that is to say translational, linear movement of the moving disconnecting contact piece for insertion into a stationary contact, which is in the form of a pot contact or tubular contact, while the contact for the grounding switch is provided by pivoting of the moving grounding contact piece. In accordance with an exemplary embodiment, the moving grounding contact piece can be in the form of a contact strip for closing all the outgoer-side contacts at the same time.

According to an exemplary embodiment of the gas-insulated high-voltage switchgear assembly according to the present disclosure, the disconnector is in the form of a linear-travel disconnector, and the grounding switch is in the form of a linear switch. In this case, the disconnecting contacts, which are guided in an outgoer-side stationary contact piece, of each phase are moved translationally in order to make contact, so that they are each inserted into an associated stationary contact piece, which is connected to the feed side. In this switch position, the stationary grounding contact piece which is arranged on the outgoer-side stationary contact piece is not connected to ground.

In accordance with an exemplary embodiment of the present disclosure, only a single drive need be provided for operation on both the disconnecting contact and the grounding contact, and may be in the form of a rocker drive or a switching rocker, for example. According to an exemplary embodiment of the present disclosure, in the case of the last-described disconnecting contact, the fixed grounding contact may be in the form of a recess, for example a hole, in the part which forms the stationary disconnecting contact piece, into which the moving grounding contact piece slides linearly and thus makes the electrical connection to the grounding contact piece, which is connected to the housing in the normal manner.

These and further advantageous refinements and improvements of the present disclosure are explained in more detail below with reference to the exemplary embodiments described with reference to the drawings.

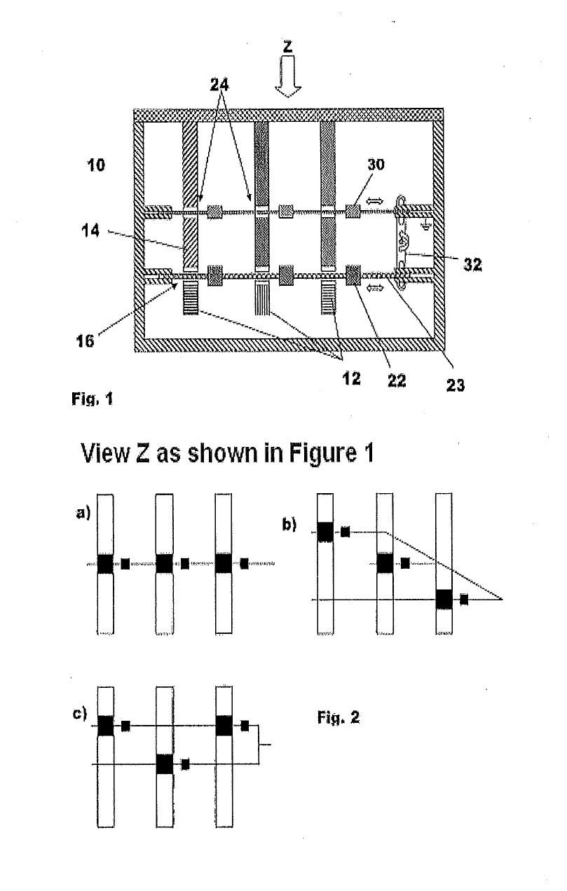

FIG. 1 shows a schematic illustration of a first contact arrangement 10 of a disconnector/grounding switch according to the present disclosure for a gas-insulated high-voltage switchgear assembly having three switch poles. The disconnecting contact pieces 22, which are used for current carrying, can be moved longitudinally on a common isolating shaft 23, in order to make contact and disconnect the contact points 16 and which are acted on via a drive by a switching rocker 32 in the opposite sense to a switching rod which operates the grounding contact pieces 30.

Parts which are the same and/or have the same function are each provided with the same reference numbers in the following text.

FIG. 2 shows three arrangements of the switch poles, which are possible in principle, within a switch housing in the form of a plan view, specifically FIG. 2a) arranged in parallel, FIG. 2b) arranged obliquely, and FIG. 2c) arranged in delta.

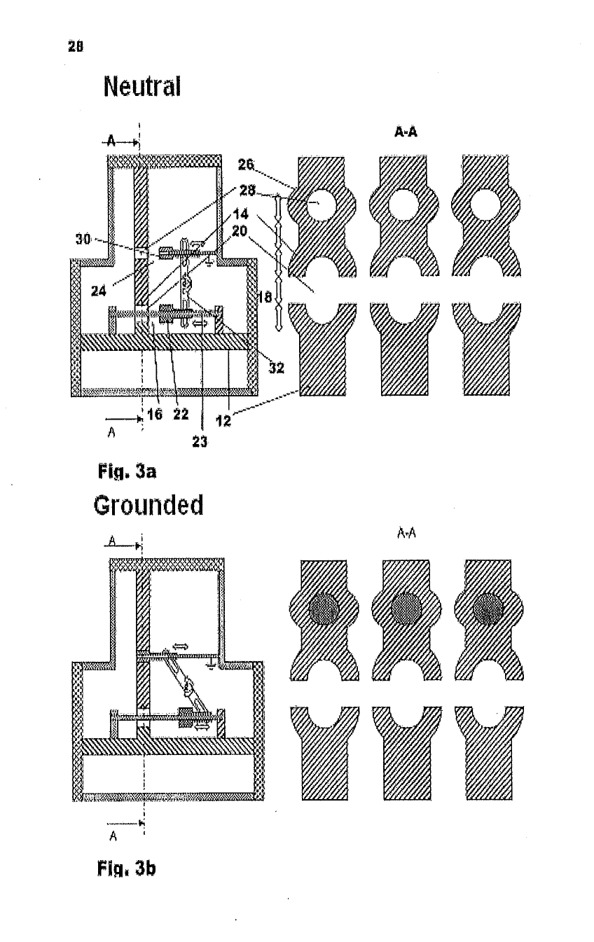

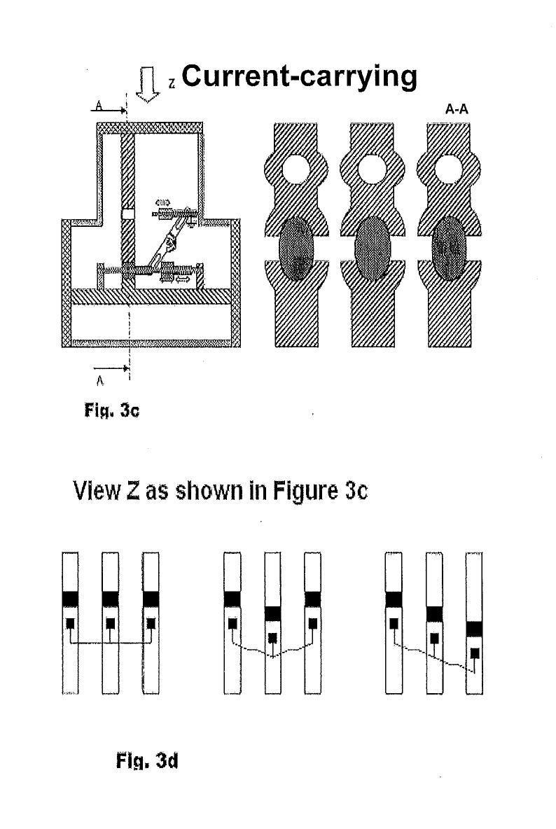

FIGS. 3a to 3d show the contact arrangement which is similar in individual switch positions to one of the first contact arrangement as explained in FIG. 1, shown on the one hand in the form of a schematic section illustration through the T-shaped switch housing and in each case alongside as a longitudinal section through the three switch poles, in each case corresponding to the section line A-A in FIGS. 3a to 3c.

In this case, identical parts are in each case provided with the same reference numbers, and the variants illustrated in FIGS. 3b and 3c show the same parts in different switch positions, without reference numbers.

The section view of the switch poles shows two horseshoe stationary contact pieces 12, 14 for each switch pole for a disconnector 16 in the neutral position, which horseshoe stationary contact pieces 12, 14 are arranged at a minimum separation corresponding to the isolating distance 18 required for safe disconnection.

In accordance with an exemplary embodiment, an elliptical moving contact piece 22, which is matched to the horseshoe contour, for closing the disconnector 16 can be inserted into the area 20 formed in this way and surrounded by the horseshoe stationary contact pieces 12, 14, as is shown by way of example in FIG. 3c.

The first horseshoe stationary contact piece 12 is in this case connected on the feed side to the current-carrying high-voltage conductor, and is accordingly always at high voltage.

The second horseshoe stationary contact piece 14, which is arranged opposite the first horseshoe stationary contact piece 12, in contrast has a stationary contact piece 26 as a common contact body with the grounding switch 24. In accordance with an exemplary embodiment, the stationary contact piece 26 is in the form of an attachment 26 and has a circular recess 28, which is used as a stationary pole contact at the grounding switch 24 and into which a moving circular-cylindrical moving grounding contact piece 30 can be inserted, for example as is shown in FIG. 1c.

FIG. 3a shows the first contact arrangement 10 in the neutral position, in which the disconnector and the grounding switch 16, 24 are each open, that is to say the moving disconnecting and grounding contact pieces 22, 30 have not been inserted into the recesses 20, 28 provided as mating contacts for this purpose.

In this illustration, the grounding contact piece 30 is shown on a first level, and the moving disconnecting contact piece 22 is shown on a second level. The contact pieces 22 and 30 are guided by an operating device 32, for example a switching rocker composed of an electrically insulating material, and are inserted alternately into the respective recesses 20 and 26 provided for this purpose, specifically between the horseshoe stationary contact pieces 12, 14, which are arranged at a distance from one another, and respectively into the circular recess 26.

Here and in the following text, a switching rocker 32 means an operating apparatus which ensures that the moving disconnecting contact pieces 22 and the moving grounding contact pieces 30 are acted on alternately in order to make contact with the associated stationary contact pieces 12, 14, 26, that is to say an apparatus which prevents contact being made simultaneously with the two moving contact pieces.

FIG. 3b shows the first contact arrangement in the grounding position, in which the disconnector 16 is open and the grounding switch 24 is closed. That is to say, the moving disconnecting contact piece 22 has been disconnected from the horseshoe stationary contact pieces 12, 14, and the moving grounding contact piece 30 has been inserted into the stationary grounding contact 28.

Finally, FIG. 3c shows the first contact arrangement of the disconnector 16 in the closed position, with the grounding switch 24 being open. In this switch position, the moving disconnecting contact 22 has been inserted into the area 20 surrounded by the horseshoe stationary contact pieces 12, 14, and accordingly makes contact with the stationary disconnecting contact formed by the horseshoe stationary contact pieces 12, 14.

A plurality of arrows are arranged at a short distance from the contact arrangement 10 between the housing section and the switch poles, and the length of each of these arrows corresponds to the isolating distance 18, that is to say to the minimum separation for safe disconnection of the horseshoe stationary contact piece 12, which carries high voltage, from the non-live horseshoe stationary contact piece 14.

This indication of the arrows is intended to show the required minimum physical size of the combined disconnector/grounding switch 10 according to an exemplary embodiment of the present disclosure, which is considerably smaller than the disconnectors/grounding switches according to known techniques and therefore represents a clear improvement since this results in the required space becoming smaller, and allows a compact configuration of the correspondingly equipped gas-insulated high-voltage switchgear assembly.

FIG. 3d shows a schematic outline illustration showing the possibility of making contact with the grounding contacts per pole and their connection for joint operation with one another. In contrast to the situation shown in FIG. 1, in the arrangement shown in FIGS. 3a to 3c, the moving disconnecting and grounding contacts are each arranged parallel to one another.

In addition, the same general statements can be made for this exemplary configuration of a contact arrangement for a combined disconnector/grounding switches 16, 24 as those for the further exemplary embodiment described with in the following text, that the operation of the moving disconnecting and grounding contact pieces 22, 30 is interlocked, such that only one of the two switches 16, 24 can ever be closed, and simultaneous closure of the disconnector 16 and of the grounding switch 24 is reliably prevented and precluded.

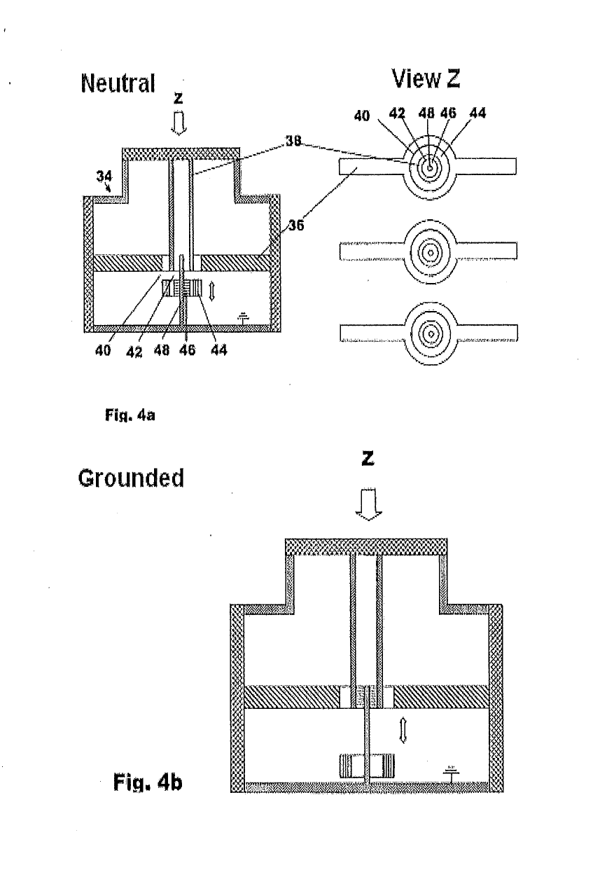

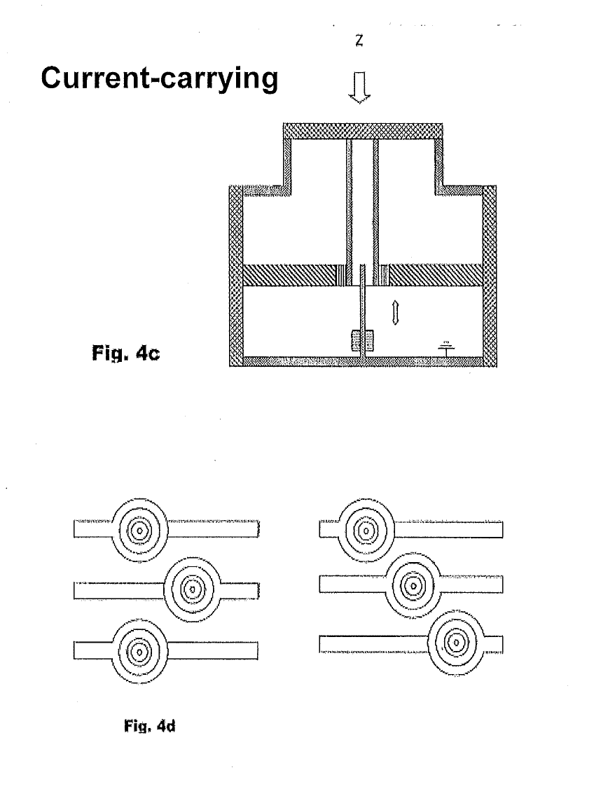

FIG. 4a shows a schematic view of a second contact arrangement 34 of a disconnector/grounding switch according to an exemplary embodiment of the present disclosure with concentric annular stationary contacts 36, 38 for the disconnector 40 and for the grounding switch 42, as can be seen from the plan view, as just illustrated, of this contact arrangement. The first stationary disconnecting contact piece 36 is in this case always connected to the high-voltage feed and is correspondingly at high voltage, while the second stationary disconnecting contact piece 38 is not connected to high voltage until contact is made with a moving disconnecting contact piece 44. In addition, the second stationary disconnecting contact piece 38 is used as a common contact body with the grounding switch 42, such that, when the disconnecting contact is switched to be non-live, that is to say when the disconnector 40 is open, the second stationary disconnecting contact piece is likewise connected to ground potential by closing the grounding switch 42.

FIG. 4a shows the combined disconnector/grounding switch in the neutral position, that is to say, in this illustration, both the disconnector 40 and the grounding switch 42 are open. In other words, the annular contact areas for respective insertion of the associated moving contact pieces 44, 46 are empty.

FIG. 4b shows a cross section through the second contact arrangement 34 along an imaginary diagonal through the center point of the annular arrangement shown in FIG. 4a, in the grounding position. The moving annular grounding contact piece 46 of the disconnector 40 in this case makes contact with the annular grounded stationary contact pieces 48, while the moving, likewise annular, disconnecting contact piece 44 is located on a second level, at a distance from the associated stationary grounding contact piece 48.

In the switch position shown in FIG. 4c, the disconnector 40 has been closed by means of the associated moving disconnecting contact piece 44, and the grounding switch 42 has been open. In this switch position, the stationary disconnecting contact piece 38 is therefore at high voltage. This represents the normal operating case of the gas-insulated high-voltage switchgear assembly, specifically with loads connected thereto being supplied with electrical power.

As can be seen from FIG. 4a to FIG. 4c, in this exemplary embodiment as well, the moving contact pieces, specifically the moving disconnecting contact piece 44 and the moving grounding contact piece 46 as shown in FIG. 4c, are each moved from a second level to the contact level in order to make contact with the respectively associated stationary contact pieces 36, 38 as well as 38 and 48.

An arrow arrangement is shown underneath the contact arrangement shown in FIG. 4c, in which case, in the same way as in FIG. 1a above, the length of a single arrow 18 in each case corresponds to the isolating distance itself, that is to say to the minimum separation for safe disconnection of the stationary contact piece 36, which is carrying high voltage, from the non-live stationary contact piece 38, and therefore indicating a measure for the physical size required for the disconnector/grounding switch to maintain an adequate isolation gap. In contrast to the embodiments shown in FIGS. 1 to 3, in this exemplary embodiment, the required physical size, which is governed by the minimum isolation gap, is reduced once again with virtually only three arrows, corresponding to a further improvement in the sense of a compact design.

FIG. 4d schematically illustrates the plan view of a second contact arrangement of a disconnector/grounding switch according to an exemplary embodiment of the present disclosure with concentric annular stationary contact pieces, with different arrangements of the switch poles with respect to one another, specifically on the one hand (on the left) arranged in delta and on the other hand (on the right) arranged inclined.

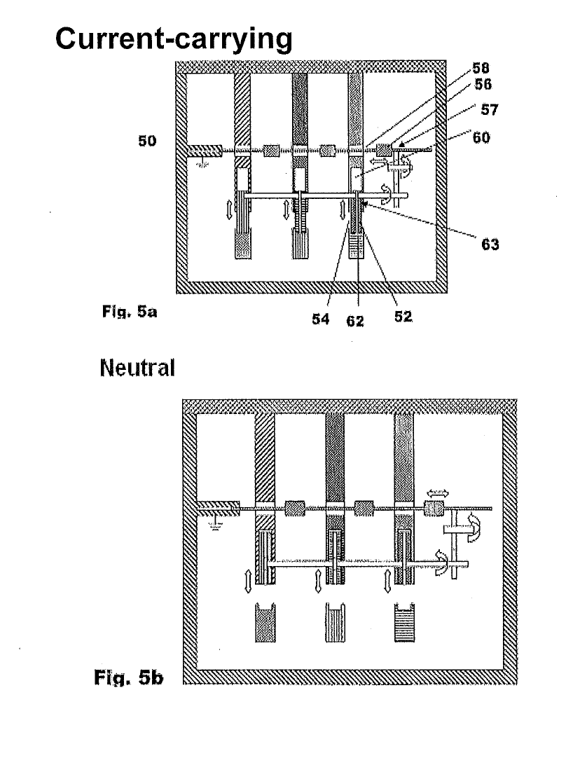

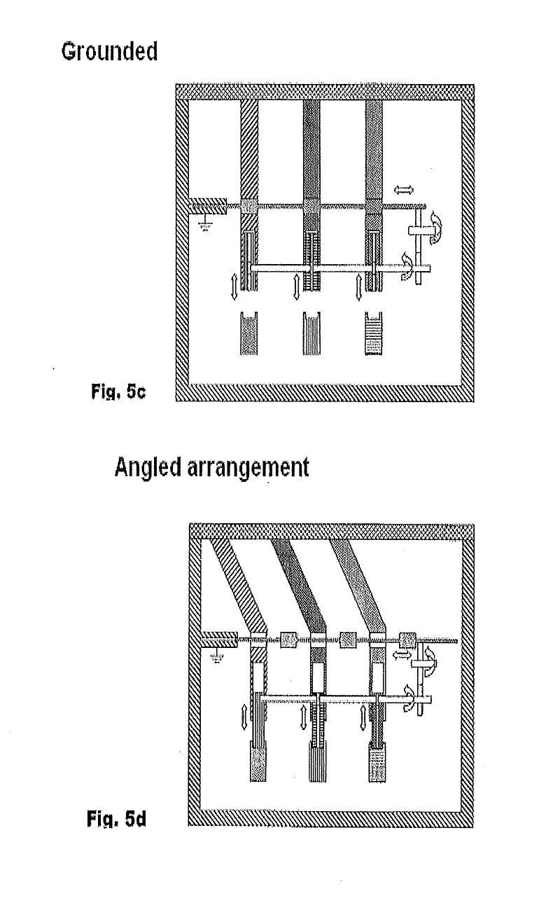

FIG. 5 shows a schematic illustration of the longitudinal section through a third contact arrangement 50 of a disconnector/grounding switch according to an exemplary embodiment of the present disclosure with three switch poles, which are each provided with a translationally moving linear-travel contact piece 52 for the disconnector 54 and with a pin contact piece 56, which likewise moves translationally transversally (orthogonally) with respect thereto, for the grounding contact 58, in three different switch positions, specifically;

FIG. 5a in the closed position of the disconnector (grounding switch open);

FIG. 5b in the neutral position (disconnector and grounding switch open);

FIG. 5c in the disconnected position (disconnector open and grounding switch closed); and

FIG. 5d shows an angled variant of the disconnector in the closed position (grounding switch open).

This contact arrangement 50 of the present disclosure likewise makes it possible to produce a design which is space-saving to the same extent as that already shown in FIGS. 1 to 4, providing the principle, which is already known per se of a translationally moving linear-travel contact piece for the moving disconnecting contact piece 52 for the disconnector 54, and for the moving grounding contact piece 56 for the grounding switch 58.

In this case, the moving disconnecting contact piece 52 is arranged in a housing 60 which is shared with the grounding switch 58, and a drive acts on it in order to move it. A mating contact, which is similar to a pot or jug, is provided as the stationary disconnecting contact piece 62, and the moving disconnecting contact piece 52 is inserted therein.

A circular recess is provided in the housing 60 as the fixed grounding contact piece, is arranged transversally with respect to the movement direction of the moving disconnecting contact piece 52, and into which the moving grounding contact piece 56 is inserted, thus ensuring the connection for ground potential.

This exemplary configuration of the third contact arrangement, specifically with the mutually angled movement planes of the moving contact pieces 52 and 56 for the disconnector 54 and for the grounding switch 58, likewise allows a space-saving design of a disconnector/grounding switch for a compact gas-insulated high-voltage switchgear assembly.

FIGS. 5a to 5d each schematically illustrate the longitudinal section through a contact arrangement of the disconnector/grounding switch according to an exemplary embodiment of the present disclosure, with in each case one moving and one stationary contact piece for the disconnector and the grounding switch, which are integrally connected to one another. However, the contact arrangement illustrated here is in the form of a three-phase switch arrangement, with the switches for all three phases being physically identical.

In this case, the disconnector has a so-called translationally moving linear-travel contact piece as the moving disconnecting contact piece, which is inserted into a stationary disconnecting contact piece similar to a pot, thus making the electrically conductive connection with the high voltage.

As the stationary grounding contact piece, the grounding switch has a cylindrical recess which is arranged in a contact body and into which a grounding contact piece can be inserted in order to make contact. The grounding contact piece is likewise in the form of a pin or peg and can move translationally.

An operating apparatus is provided for operation of the moving disconnecting contact piece. In accordance with an exemplary embodiment, the operating apparatus acts on all three phases at the same time, that is to say the respective moving disconnecting contact piece is inserted into the associated stationary disconnecting contact piece in order to make contact with it, or is in each case moved out of it in order to interrupt the respective contact.

The operating apparatus is operated by a drive which is also used to operate the moving grounding contact pieces in which it transmits the respective actuating movement to a spindle drive or the like, which itself moves the moving grounding contact pieces linearly into the associated recess in the contact body.

According to the exemplary embodiment of this contact arrangement, this drive is in the form of a rotating/linear-movement drive in which the rotational movement is converted to a translational movement, for example, by means of a slotted-link guide or a direction-changing transmission, possibly in conjunction with a toothed rod, thus resulting in the respective operation of the moving contact pieces.

FIG. 5d shows a schematic illustration of the longitudinal section through an alternative three-phase contact arrangement of a disconnector/grounding switch according to an exemplary embodiment of the present disclosure, which operates essentially on the same principle as the contact arrangement shown in FIG. 5a and FIG. 5c.

The difference in this exemplary contact arrangement is that, although the disconnector and the grounding switch are connected integrally to one another, they are, however, angled with respect to one another.

The contact body for the disconnector and grounding switch is accordingly functionally the same as the contact body shown in FIG. 5, that is to say on the one hand a translationary moving disconnecting contact piece for the disconnector is guided therein. The disconnecting contact piece is inserted into the associated stationary disconnecting contact piece, which is in the form of a pot contact, as well as a recess or contact surface, which is used as the stationary grounding contact piece and is pivoted in for contact-making by, or makes an area contact with, a moving grounding contact piece, which is in the form of a pin contact or an area contact, for the grounding contact.

In this case, the moving disconnecting and grounding contact pieces are operated in a comparable manner to that of the contact arrangement shown in FIG. 5.

In accordance with an exemplary embodiment, only one drive is provided for the operation of the moving disconnecting and grounding contacts. In this case, the operating apparatus can be operated by a drive which is used for operation of the moving disconnecting and grounding contact pieces, by transmitting the respective actuating movement to a toothed-rod drive, spindle drive or the like, at the same time if required, also providing rotary operation and the translational operation, and itself moving the moving grounding contact pieces linearly into the associated recess or to the contact-making surface which is provided for this purpose on the contact body.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 First contact arrangement
12 Horseshoe stationary contact piece
14 Horseshoe stationary contact piece
16 Disconnector
18 Isolating distance
20 Recess
22 Moving disconnecting contact piece
23 Guide rod composed of insulating material
24 Grounding switch
26 Stationary grounding contact piece, attachment
28 Circular recess
30 Moving grounding contact piece
32 Operating apparatus
34 Second contact arrangement
36 First stationary disconnecting contact piece
38 Second stationary disconnecting contact piece
40 Disconnector
42 Grounding switch
44 Moving disconnecting contact piece
46 Moving grounding contact piece
48 Stationary grounding contact piece
50 Third contact arrangement
52 Moving disconnecting contact piece
54 Disconnector
56 Moving grounding contact piece
57 Drive for grounding switch
58 Grounding switch
60 Stationary grounding contact piece, housing
62 Stationary disconnecting contact piece
63 Drive for disconnector

What is claimed is:

1. A three-phase gas-insulated high-voltage switchgear assembly comprising:
a housing with in each case one corresponding switch module with a drive for each phase;
at least one busbar;
a control module;
a cable outgoer;
a current transformer;
a disconnector; and
a corresponding grounding switch in each case for each phase,
wherein the disconnector and the grounding switch being spatially and physically separated from one another and being operable by a common drive.

2. The three-phase gas-insulated high-voltage switchgear assembly as claimed in claim 1, wherein the disconnector has a higher current carrying capability than the grounding switch.

3. The three-phase gas-insulated high-voltage switchgear assembly as claimed in claim 2, wherein the higher current carrying capability of the disconector is based on the disconnector having a larger contact cross section than the grounding switch.

4. The three-phase gas-insulated high-voltage switchgear assembly as claimed in claim 1, wherein the disconnector and the grounding switch are arranged concentrically with respect to one another, and
wherein the disconnector concentrically surrounds the grounding switch, at a distance.

5. The three-phase gas-insulated high-voltage switchgear assembly as claimed in claim 1, wherein the disconnector is in the form of a line disconnector with two horseshoe stationary disconnecting contact pieces, between which a moving disconnecting contact piece is insertable to make contact, and
wherein the stationary contact piece of the grounding switch has a cylindrical recess, in which the moving grounding contact piece engages, as a pin contact for making contact.

6. The gas-insulated high-voltage switchgear assembly as claimed in claim 1, wherein the disconnector is in the form of a linear-travel disconnector with a stationary disconnecting contact piece, into which the moving disconnecting contact piece is insertable to make contact, and
wherein the grounding switch is in the form of a cylindrical recess in a contact body into which a moving grounding contact piece is insertable.

7. The three-phase gas-insulated high-voltage switchgear assembly as claimed in claim 6, wherein the disconnector and the grounding switch have a common contact body, which is configured as a stationary contact piece for grounding.

8. The three-phase gas-insulated high-voltage switchgear assembly as claimed in claim 7, wherein the operation of the disconnector and of the grounding switch is interlocked such that at most one of the two switches is ever closed.

9. The three-phase gas-insulated high-voltage switchgear assembly as claimed in claim 6, wherein the moving disconnecting contact piece is guided to be moveable longitudinally in the common contact body of the disconnector and the grounding switch.

10. The three-phase gas-insulated high-voltage switchgear assembly as claimed in claim 9, wherein the common contact body is configured to hold the moving disconnecting contact piece completely therein.

11. The three-phase gas-insulated high-voltage switchgear assembly as claimed in claim 9, wherein the common contact body is uniformly stretched.

12. The three-phase gas-insulated high-voltage switchgear assembly as claimed in claim 9, wherein the common contact body is partially angled.

13. The three-phase gas-insulated high-voltage switchgear assembly as claimed in claim 12, wherein the common contact body is angled such that the moving disconnecting contact piece is moveable linearly without impediment and there is sufficient space for the associated operating drive.

14. The three-phase gas-insulated high-voltage switchgear assembly as claimed in claim 5, comprising:
a linear-movement/rotating drive for operation of the moving contact pieces of the disconnector and of the moving contact pieces of the grounding switch, the linear-movement/rotating drive being configured to convert a rotary movement to a longitudinal movement and vice versa.

15. The three-phase gas-insulated high-voltage switchgear assembly as claimed in claim 5, comprising:
a switching rocker for operation of the moving contact pieces of the disconnector and of the moving contact pieces of the grounding switch, by means of the switching rocker only one moving contact piece makes contact with the associated contact point, and the other moving contact piece is at a distance from the associated contact point, so as to prevent simultaneous closure of the contact points which are provided for each moving contact piece.

16. The three-phase gas-insulated high-voltage switchgear assembly as claimed in claim 3, wherein the disconnector and the grounding switch are arranged concentrically with respect to one another, and
wherein the disconnector concentrically surrounds the grounding switch, at a distance.

17. The three-phase gas-insulated high-voltage switchgear assembly as claimed in claim 3, wherein the disconnector is in the form of a line disconnector with two horseshoe stationary disconnecting contact pieces, between which a moving disconnecting contact piece is insertable to make contact, and
wherein the stationary contact piece of the grounding switch has a cylindrical recess, in which the moving grounding contact piece engages, as a pin contact for making contact.

18. The gas-insulated high-voltage switchgear assembly as claimed in claim 3, wherein the disconnector is in the form of a linear-travel disconnector with a stationary disconnecting contact piece, into which the moving disconnecting contact piece is insertable to make contact, and
wherein the grounding switch is in the form of a cylindrical recess in a contact body into which a moving grounding contact piece is insertable.

19. The three-phase gas-insulated high-voltage switchgear assembly as claimed in claim 18, wherein the disconnector and the grounding switch have a common contact body, which is configured as a stationary contact piece for grounding.

20. The three-phase gas-insulated high-voltage switchgear assembly as claimed in claim 19, wherein the operation of the disconnector and of the grounding switch is interlocked such that at most one of the two switches is ever closed.

21. The three-phase gas-insulated high-voltage switchgear assembly as claimed in claim 19, wherein the moving disconnecting contact piece is guided to be moveable longitudinally in the common contact body of the disconnector and the grounding switch.

22. The three-phase gas-insulated high-voltage switchgear assembly as claimed in claim 21, wherein the common contact body is configured to hold the moving disconnecting contact piece completely therein.

23. The three-phase gas-insulated high-voltage switchgear assembly as claimed in claim 22, wherein the common contact body is uniformly stretched.

24. The three-phase gas-insulated high-voltage switchgear assembly as claimed in claim 22, wherein the common contact body is partially angled.

25. The three-phase gas-insulated high-voltage switchgear assembly as claimed in claim 24, wherein the common contact body is angled such that the moving disconnecting contact piece is moveable linearly without impediment and there is sufficient space for the associated operating drive.

26. The three-phase gas-insulated high-voltage switchgear assembly as claimed in claim 18, comprising:
a linear-movement/rotating drive for operation of the moving contact pieces of the disconnector and of the moving contact pieces of the grounding switch, the linear-movement/rotating drive being configured to convert a rotary movement to a longitudinal movement and vice versa.

27. The three-phase gas-insulated high-voltage switchgear assembly as claimed in claim 17, comprising:
a switching rocker for operation of the moving contact pieces of the disconnector and of the moving contact pieces of the grounding switch, by means of the switching rocker only one moving contact piece makes contact with the associated contact point, and the other moving contact piece is at a distance from the associated contact point, so as to prevent simultaneous closure of the contact points which are provided for each moving contact piece.

28. The three-phase gas-insulated high-voltage switchgear assembly as claimed in claim 6, wherein the stationary disconnecting contact piece is substantially in the form of a pot.
